(19) United States
(12) Patent Application Publication
(10) Pub. No.: US 2014/0006102 A1
(43) Pub. Date: Jan. 2, 2014

(54) SYSTEMS, METHODS AND COMPUTER-READABLE MEDIA FOR OPTIMIZING TRANSACTIONS IN A HOUSEHOLD ADDRESSABLE MEDIA NETWORK

(71) Applicant: Visible World, Inc., New York, NY (US)

(72) Inventors: Seth Haberman, New York, NY (US); Gerrit Niemeijer, Maplewood, NJ (US); Robert Bress, Springfield, NJ (US)

(21) Appl. No.: 13/921,733

(22) Filed: Jun. 19, 2013

Related U.S. Application Data
(60) Provisional application No. 61/661,598, filed on Jun. 19, 2012.

(51) Int. Cl. G06Q 30/02

(52) U.S. Cl. CPC G06Q 30/0201
USPC 705/7.29

(57) ABSTRACT

Systems, methods and computer-readable storage media for optimizing transactions in a household addressable media network are described. Transaction information associated with past transactions involving the sale of inventory for the media network, such as the sale of an audience and/or segments of the audience. Potential transaction information may be configured to indicate projected conditions for a future sale media network inventory for certain media content of a potential purchaser, such as a media content provider. An example media content provider is an advertiser seeking to purchase an audience or segments thereof for broadcast of an advertisement. A model for selling the inventory may be configured based on the past information. A simulated selling of the inventory and/or segments thereof may be performed to generate potential sales information that may be used to optimize future inventory sales. An illustrative simulation model may include an agent-based computational economics (ACE) model.

### CROSS REFERENCE TO RELATED APPLICATIONS

This application claims the benefit of U.S. Provisional Application No. 61/661,598 filed on Jun. 19, 2012, the contents of which are incorporated by reference in their entirety as if fully set forth herein.

### FIELD OF INVENTION

The described technology generally relates to optimizing media content transactions within a media network, and more specifically to developing models and/or simulations for determining optimized strategies for selling audience segments for said media content based on past and/or potential transaction information.

### BACKGROUND

Media networks may sell openings or slots to content providers to broadcast certain content on their systems. A common example is a cable television network selling time on a television network to an advertiser to broadcast an advertisement. The media network may sell different time slots at different prices based on certain conditions, such as the demand for a particular time slot. For instance, a time slot during a television program with high ratings will be more valuable that a time slot during a television program with lower ratings. As such, media networks operate using a time-slot pricing strategy that maximizes the cost of a time slot based on information associated with the time slot, such as ratings-based demand.

In a household addressable media network, a media network operator is capable of providing particular content to individual households and/or segments of the network audience. As such, in addition to selling time slots, a media network may sell portions of the audience to a content provider. However, there are risks involved in basing transactions on a segmented audience. For example, the media network may be able to sell a particular segment at a premium price, but if the remaining segments do not sell, then the media network may realize less revenue than if the whole audience was sold to a content provider. Current technology does not provide media network operators with the information necessary to determine whether more revenue would be generated by selling the entire audience or segments of the audience for a particular transaction. Accordingly, it would be beneficial for a media network operator to be able to generate information configured to provide an optimized strategy for selling a media network audience and segments thereof.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for optimizing transactions in a household addressable media network may comprise a processor and a non-transitory, computer-readable storage medium in operable communication with the processor. The computer-readable storage medium may contain one or more programming instructions that, when executed, cause the processor to: receive transaction information comprising past transaction information and potential transaction information associated with an audience of the media network, the audience comprising a plurality of audience segments, receive media content information associated with at least one media content element, generate a model for selling the inventory based on the past information, generate potential sales information through a simulated selling of at least one of the plurality of audience segments using the model, the simulated selling being based on the potential information and the media content information, and generate an optimized transaction strategy for selling the plurality of audience segments for the at least one media content element based on the potential sales information.

In an embodiment, a computer-implemented method for optimizing transactions in a household addressable media network may comprise receiving transaction information comprising past transaction information and potential transaction information associated with an audience of the media network, the audience comprising a plurality of audience segments. The method may further comprise receiving advertising information associated with at least one advertisement, generating a model for selling the inventory based on the past information, generating potential sales information through a simulated selling of at least one of the plurality of audience segments using the model, the simulated selling being based on the potential information and the advertising information, and generating an optimized transaction strategy for selling the plurality of audience segments for the at least one advertisement based on the potential sales information.

In an embodiment, a computer-readable storage medium having computer-readable program code configured to optimize transactions in a household addressable media network embodied therewith. The computer-readable program code comprising computer-readable program code configured to receive transaction information comprising past transaction information and potential transaction information associated with an audience of the media network, the audience comprising a plurality of audience segments, receive advertising information associated with at least one advertisement, generate a model for selling the inventory based on the past information, generate potential sales information through a simulated selling of at least one of the plurality of audience segments using the model, the simulated selling being based on the potential information and the advertising information, and generate an optimized transaction strategy for selling the plurality of audience segments for the at least one advertisement based on the potential sales information.

### BRIEF DESCRIPTION OF THE DRAWINGS

The above and other objects of the present invention will become more readily apparent from the following detailed description taken in connection with the accompanying drawings.

FIG. 1 depicts an illustrative media network according to some embodiments.

FIG. 2 depicts an illustrative transaction optimization system according to some embodiments.

FIG. 3 depicts a flow diagram of an illustrative method of optimizing transactions in a household addressable media network according to some embodiments.

FIG. 4 depicts a block diagram of exemplary internal hardware that may be used to contain or implement various computer processes and systems.

### DETAILED DESCRIPTION

The described technology is directed to optimizing transactions for media content within a media network. For example, embodiments may be configured to optimize the sale of household addressable media network inventory that includes an audience divided into segments. Household addressable refers generally to the ability to target content to one or more households and/or household segments within the media network. According to some embodiments, transaction information may be obtained for the media network audience that includes past market transactions and potential market transactions. The transaction information may be used to generate a model configured to represent the sale of media content within the media network. In an embodiment, the media content may include an advertisement or an advertising campaign. The model may be used to simulate the sale of the whole audience and/or segments of the audience in order to determine an optimized transaction strategy. For instance, the simulation may be configured to determine whether one or more transaction values, such as revenue yield, may be optimized if media content is sold to the whole audience or to segmented pieces of the audience. The simulation may be configured to determine optimal pricing strategies, for example, for selling audience segments.

The described technology provides multiple technological advantages. A non-limiting example of an advantage is that the simulation may allow a media network operator to make optimal transaction decisions for selling the audience to a media content provider that are not available using existing technology. Another non-limiting example of an advantage is that a media operator may use the results of the simulation to determine optimal pricing of the audience and/or audience segments that existing technology is not able to provide. The technological advantages may allow, among other things, media networks to increase demand for the network to content providers interested in buying on audience segment basis.

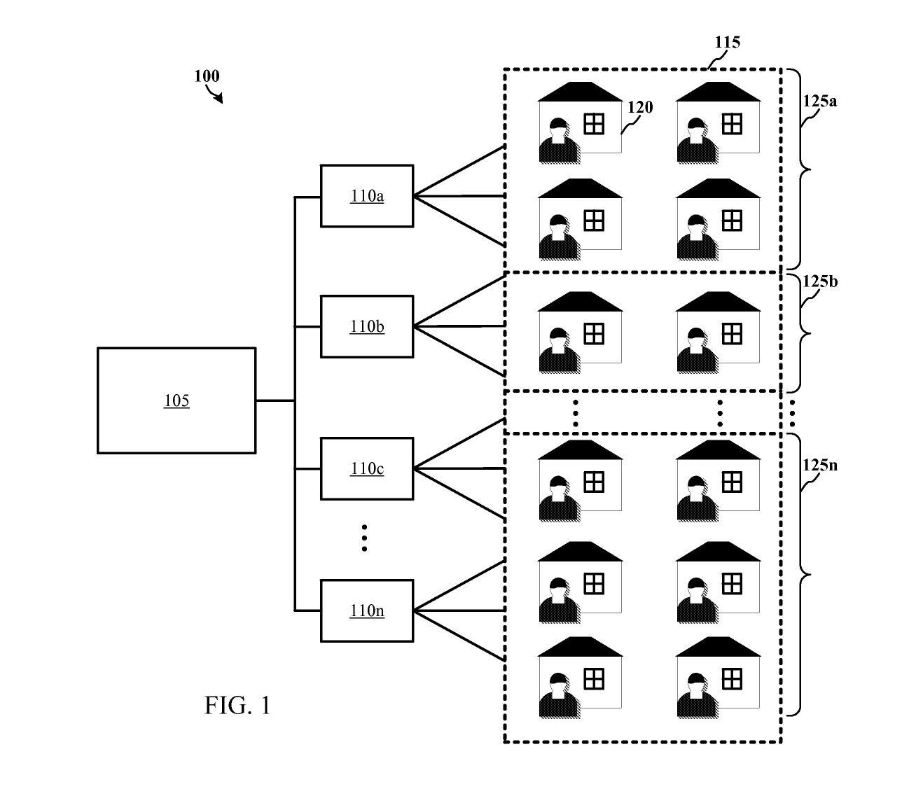

FIG. 1 depicts an illustrative media network according to some embodiments. As shown in FIG. 1, a media network 100 may include a media content provider 105. Non-limiting examples of a media content provider 105 include a television broadcast network, a cable television network, a satellite television network, an internet service provider (ISP), a computing device advertising network, or combinations thereof. The media content provider 105 may transmit content to one or more local content systems 110a-110n configured to communicate with an audience 115 of the media network 100. The local content systems 110a-110n may include equipment and systems configured to transmit media content received from the media content provider 105 to a defined portion of the audience 115. Illustrative and non-restrictive examples of a local content system 110a-110n include a cable television network headend, an internet service provider base station, or the like.

According to embodiments, the media content provider 105 may be configured to operate across physical device platforms and networks simultaneously. For example, content may be delivered to set-top-boxes (STBs) over a cable television system, to mobile computing devices using standard network communication protocols (for instance, Ethernet or Wi-Fi) over an ISP network, and to smart phone devices over standard telecommunication protocols (for instance, third Generation (3G), fourth Generation (4G), long-term evolution (LTE), or the like).

The audience 115 may include a plurality of households 120 capable of receiving media content from the media network 100 through various devices, including, without limitation, a STB, a television, a personal computer (PC), a laptop computer, a mobile computing device, a smartphone, a tablet computing device, or the like. Although multiple households 120 are depicted in FIG. 1, only one is labeled to simplify the figure. The audience 115 may be divided into segments 125a-125n based on various segmentation factors. Non-limiting examples of segmentation factors include age, gender, occupation, years of home ownership, household size, income, geographic location, family size, media consumption habits, and combinations thereof. For example, an audience segment may include males between the ages of 25 to 35 with an annual income above $50,000.

According to some embodiments, the audience may be household addressable such that the media content provider 105 and/or the local content systems 110a-110n may direct particular content directly to each household 120 and/or segments 125a-125n of the audience 115. According to some embodiments, content may generally include any type of data capable of being received and consumed by a recipient. Illustrative and non-restrictive examples of content include advertising, entertainment programs, informational programs, messages, video, audio, graphical, and/or animated content.

The media network 105 may direct particular media content, such as an advertisement or a television program, only to certain segments 125a-125n. As such, the operator of the media network may sell the entire audience 115 or only segments 125a-125n of the audience to content providers, such as advertisers, program creators, or the like.

Household addressable technology allows for content providers to buy an audience as opposed to simply buying inventory on specific networks, dayparts, programming, or the like. The ability to buy a segment 125a-125n of the whole audience 115 presents a challenge to inventory sellers, such as the media content provider 105. For instance, the media content provider 105 may be required to determine whether it is more economical to sell to content providers, such as advertisers, on the basis of the whole audience 115 or on the basis of individual segments 125a-125n and risk having a portion of the audience as unsold or underutilized inventory. Accordingly, embodiments provide systems and methods for determining, among other things, whether it is more economical to sell the whole audience 115 or segments 125a-125n thereof and, if segments are to be sold, optimal pricing for selling the segments.

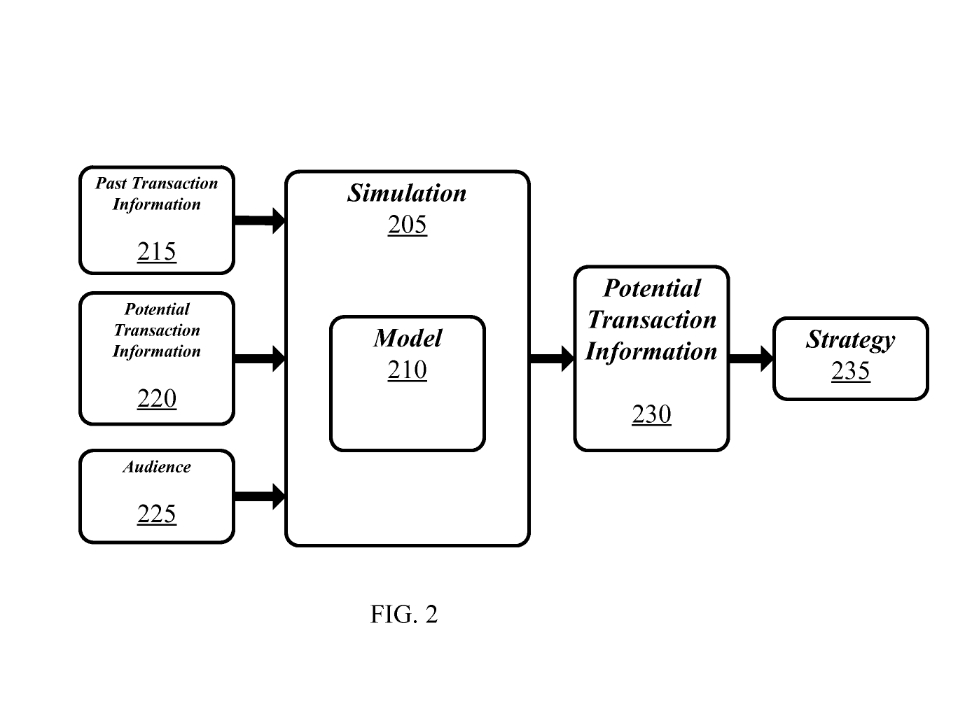

FIG. 2 depicts an illustrative transaction optimization system according to some embodiments. As shown in FIG. 2, the system may include a model 210 configured to represent the sale of a media network audience. In an embodiment, the model 210 may be generated using various input components, including, without limitation, past transaction information 215, potential transaction information 220, and an audience 225. The past transaction information 215 may include information involving past transactions, including pricing, audience information, supply and demand information, date and time information, media content information, programming information, or the like. The media content information may include information about the media content that is the subject of the sale, such as information about an advertisement including the type of advertisement, the target of the advertisement (for example, target audience segments) or the like. The potential transaction information 220 may include information types that are similar to the past transaction information 215, with simulated values, for instance, for projected market conditions. For example, the potential transaction information 220 may include projected supply and demand information for an audience. The potential transaction information 220 may include strategy information, such as strategies for selling the audience to potential buyers (for example, selling the entire audience, selling segments of the audience at particular pricing), for certain media content, and/or under specified conditions (for instance, supply and demand conditions). The audience 225 may include the media network audience available to be sold as part of the simulated transaction, including individual segments of the audience.

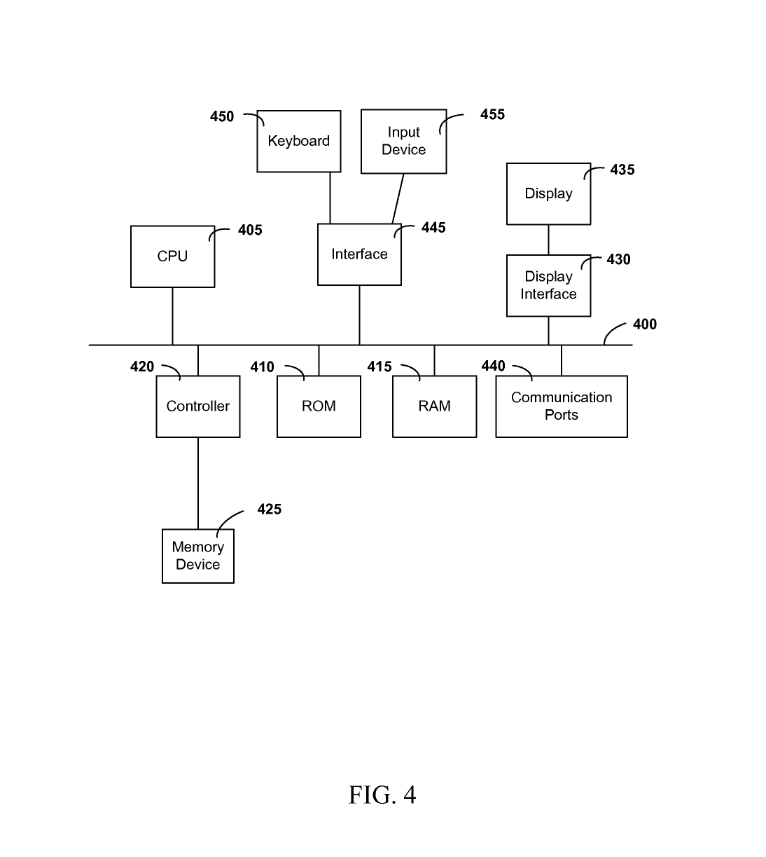

A simulation 205 component may be configured to simulate the sale of media network audience and/or segments thereof based on the model 210 and the input components 215-225. Although FIG. 2 depicts past transaction information 215, potential transaction information 220, and audience 225 input components, embodiments are not so limited. For instance, any input component capable of providing information for simulating the sale of a media network audience and/or segments thereof is contemplated herein. In an embodiment, the simulation component 205 may be configured as a simulation application configured to be executed on a logic device, such as a logic device including the internal hardware depicted in FIG. 4. In such an embodiment, the model 210 may be configured as a module of the simulation component or as a model application configured to be executed on a logic device in operable communication with the simulation application.

According to some embodiments, the input components 215-225 may be fluid such that values associated therewith may be modified, fluctuate, or otherwise change during the simulation. In this manner, the simulation 205 may be configured to model dynamic, real-world conditions. In an embodiment, the input components 215-225 may be generated in real-time or substantially real time, for example, based on transaction activity within the media network. The information associated with the input components 215-225 may be stored in one or more data stores in operative communication with the one or more logic devices executing the simulation application. Information generated by operation of the media network, information generated by the media network operator (for example, projected information), third party information, or any other source of information stored in the one or more data stores may be accessed in substantially real-time by the simulation application. In this manner, the simulation 205 component, the model 210, and/or the input components 215-225 may be updated, modified, or otherwise changed to reflect real-time conditions and/or simulation of a different strategy.

The simulation 205 component and/or the model 210 may be configured according to various simulation techniques. In an embodiment, the simulation component 205 may be configured according to agent-based computational economics (ACE) modeling. In general, ACE refers to the computational study of economic processes modeled as dynamic systems of interacting agents that may not possess perfect rationality and/or information. ACE may be configured to use simulated agents with varying behavior, for instance, to determine the best market strategy under different market conditions. Starting from initial conditions specified, for instance, by the model 210, the computational economy may evolve over time as its constituent agents repeatedly interact with each other and learn from these interactions.

In an embodiment, the agents within an ACE model may be configured to model the audience 215 and/or segments thereof. In another embodiment, the agents may be modeled based on various conditions, such as past supply, demand, transaction prices, or the like. In a further embodiment, the agents may be modeled as buyers (for example, advertisers and other content providers) and sellers (for example, media network operators). The ACE model 210 may be configured to specify the initial state of the economy, for example, the media network 100 depicted in FIG. 1, by specifying the initial attributes of the agents. The initial attributes of an agent may include type characteristics, behavioral norms, modes of behavior, and information about itself and other agents. In an embodiment, the agents may be configured using information obtained from the input components 215-225. The economy may evolve as the simulation 205 using the model 210 operates to generate potential sales information 230 involving, among other things, the projected sales of the audience 215 and segments thereof.

According to some embodiments, the simulation 205 and the model 210 may be configured using the past transaction information 215 and the potential transaction information 220 to assess optimal strategies under varying conditions, such as varying supply and demand. The simulation 205 may be configured to estimate various conditions and circumstances. For instance, the simulation 205 may be configured to estimate how past whole audience transactions may have been segmented. In another instance, the simulation 205 may be configured to introduce new conditions into the transaction environment, such as new demand, supply, and/or pricing conditions for selling the media content to the whole audience 215 and/or segments thereof

The simulation 205 may be configured to simulate the dynamic interaction between buyers (for example, advertisers and other content providers) and sellers (for example, media network operators) to provide potential sales information 230 configured to provide how the sale of audience may have responded to different sales strategies. For instance, the simulation 205 may be configured to provide potential sales information 230 indicating the likelihood of selling the remaining segments when one or more other segments are sold. In an embodiment, the potential sales information 230 may be used to generate a strategy 235, such as an optimal transaction strategy.

According to some embodiments, the strategy 235 may include information indicating whether it is optimal to sell the whole audience or whether it is optimal to sell segments of the audience. The strategy 235 may also include information indicating the pricing of segments if a segment-based transaction strategy is implemented. A strategy 235 may be configured to provide an optimal solution for selling the audience and/or segments thereof for particular media content under a certain set of conditions. For example, the potential sales information 230 may indicate segment pricing based on the likelihood of selling the remaining segments. In another example, the potential sales information 230 may indicate that it is more economical to sell the entire audience and not to divide up the audience according to segments. Accordingly, the simulation 205 may be configured to determine an optimal transaction strategy 235 under the highly dynamic and complex conditions present within a media content network and the audience thereof. The simulation 205 may provide a solution for a media network “pick-and-pack” problem in which the simulation generates a strategy 235 configured to solve for the best way to fulfill demand for different types of audience buying (for example, whole audience or audience segment) in order to maximize one or more transaction values while ensuring that all inventory is sold.

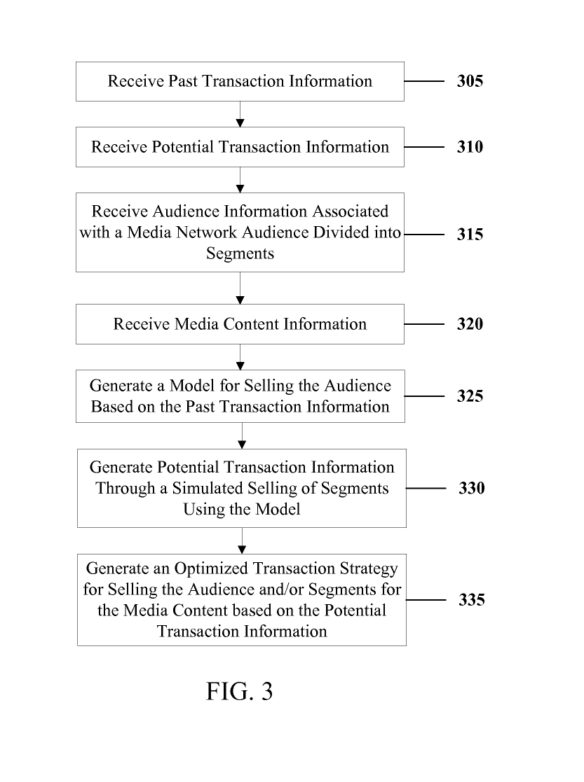

FIG. 3 depicts a flow diagram of an illustrative method of optimizing transactions in a household addressable media network according to some embodiments. As shown in FIG. 3, a simulation application may be configured to receive 305 past transaction information for a media network. For example, the past transaction information may include information associated with supply, demand, pricing, media content, an audience, and/or audience segments. According to some embodiments, the past transaction information may provide information associated with past transactions on the media network for a particular audience. The past transaction information may be used by the simulation application as a basis for how transactions have transpired in the past for a particular audience and/or audience segments for certain media content (for example, an advertisement) under particular conditions (for example, supply, demand, pricing, day and time, programming, or the like).

The simulation application may be configured to receive 310 potential transaction information. For example, the potential transaction information may include projected information for supply, demand, pricing, media content, an audience, and/or audience segments for a particular media network. According to some embodiments, the potential transaction information may be configured to simulate the selling of an audience and/or audience segments under projected conditions in order to generate predictions about certain transactional values. In an embodiment, the transactional values may include any value configured to indicate an assessment of the transaction, including revenue, revenue yield, profit, total sales, or the like.

Audience information may be received 315 by the simulation application that is associated with a media network audience divided into segments. For example, the audience information may include information indicating the households that make up the audience, such as demographic, salary, education, employment, and purchase interest information. The audience information may also include the number, type, and/or location of audience segments as well as the basis for placing households into particular segments (for example, age, gender, or the like). The simulation application may receive 320 media content information associated with media content (for example, an advertisement, an advertising campaign, a program, a message, or the like) that is the subject of the transaction and/or potential transaction. For example, the media content information may include the substance and/or content of the media content, target audience, target demographics, day and/or time for making the media content available, or the like. The media content information may be used, among other things, to compare media content offerings that are the subject of a transaction, for instance, for comparative purposes. In this manner, a simulation may be performed for non-identical media content.

A model for selling the audience based on the past transaction information may be generated 325, for example, by the simulation application or through a model application. The model may be configured to represent a transaction involving media content and a particular audience and/or audience segments. The model may be generated 325 in order to comply with various simulations, such as an ACE simulation.

Potential transaction information may be generated 330 by the simulation application by using the model and various information sources, such as the past transaction information, the potential transaction information, the advertising information, and/or the audience information. The potential transaction information may be generated 330 through a simulated selling of the audience using the simulation application and the information received thereby. In an embodiment, the simulation application may be configured to generate 330 the potential transaction information using an ACE simulation configuration. The potential transaction information may include information that may indicate the result of one or more transactions of an audience and/or particular audience segments for media content under certain conditions. The potential transaction information may be used to generate 335 an optimized transaction strategy for selling the audience and/or the segments for the media content. For example, the optimized transaction strategy may specify that certain transaction values, such as revenue yield, may be optimized if one or more segments are sold individually. In another example, the optimized transaction strategy may specify that certain transaction values may be optimized if the audience as a whole is sold to the media content provider. In this manner, a media network operator may make an informed decision based on the potential transaction information and/or optimized transaction strategy when making transaction decisions for the media network.

FIG. 4 depicts a block diagram of exemplary internal hardware that may be used to contain or implement the various computer processes and systems as discussed above. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 430 and random access memory (RAM) 435 constitute exemplary memory devices.

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices. Additionally, the memory devices 425 may be configured to include individual files for storing any software modules or instructions, auxiliary data, common files for storing groups of results or auxiliary, or one or more databases for storing the result information, auxiliary data, and related information as discussed above. For example, the memory devices 425 may be configured to store judicial information source 315.

Program instructions, software or interactive modules for performing any of the functional steps associated with the analysis of judicial decision making as described above may be stored in the ROM 430 and/or the RAM 435. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 430 may permit information from the bus 400 to be displayed on the display 435 in audio, visual, graphic or alphanumeric format. The information may include information related to a current job ticket and associated tasks. Communication with external devices may occur using various communication ports 440. An exemplary communication port 440 may be attached to a communications network, such as the Internet or a local area network.

The hardware may also include an interface 445 which allows for receipt of data from input devices such as a keyboard 450 or other input device 455 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system for optimizing transactions in a household addressable media network, the system comprising:
a processor; and
a non-transitory, computer-readable storage medium in operable communication with the processor, wherein the computer-readable storage medium contains one or more programming instructions that, when executed, cause the processor to:
receive transaction information comprising past transaction information and potential transaction information associated with an audience of the media network, the audience comprising a plurality of audience segments;
receive media content information associated with at least one media content element;
generate a model for selling the inventory based on the past information;
generate potential sales information through a simulated selling of at least one of the plurality of audience segments using the model, the simulated selling being based on the potential information and the media content information; and
generate an optimized transaction strategy for selling the plurality of audience segments for the at least one media content element based on the potential sales information.

2. The system of claim 1, wherein the past transaction information comprises at least one of supply, demand, pricing, and a media content element.

3. The system of claim 1, wherein potential transaction information comprises projected information for at least one of the following: supply, demand and pricing.

4. The system of claim 1, wherein the media content element comprises at least one advertisement.

5. The system of claim 1, wherein the audience segments are segmented based on demographic information of the audience.

6. The system of claim 1, wherein the simulated selling is configured according to an agent-based computational economics simulation.

7. The system of claim 6, wherein agents of the agent-based computational economics simulation are configured to model buyers and sellers of the audience.

8. The system of claim 1, wherein the optimized transaction strategy is configured to optimize revenue yield.

9. A computer-implemented method for optimizing transactions in a household addressable media network, the method comprising, by a processor:
receiving transaction information comprising past transaction information and potential transaction information associated with an audience of the media network, the audience comprising a plurality of audience segments;
receiving advertising information associated with at least one advertisement;
generating a model for selling the inventory based on the past information;
generating potential sales information through a simulated selling of at least one of the plurality of audience segments using the model, the simulated selling being based on the potential information and the advertising information; and
generating an optimized transaction strategy for selling the plurality of audience segments for the at least one advertisement based on the potential sales information.

10. The method of claim 9, wherein the past transaction information comprises at least one of supply, demand, pricing, and a media content element.

11. The method of claim 9, wherein potential transaction information comprises projected information for at least one of the following: supply, demand and pricing.

12. The method of claim 9, wherein the media content element comprises at least one advertisement.

13. The method of claim 9, wherein the audience segments are segmented based on demographic information of the audience.

14. The method of claim 9, wherein the simulated selling is configured according to an agent-based computational economics simulation.

15. The method of claim 14, wherein agents of the agent-based computational economics simulation are configured to model buyers and sellers of the audience.

16. The method of claim 9, wherein the optimized transaction strategy is configured to optimize revenue yield.

17. A computer-readable storage medium having computer-readable program code configured to optimize transactions in a household addressable media network embodied therewith, the computer-readable program code comprising:
computer-readable program code configured to receive transaction information comprising past transaction information and potential transaction information associated with an audience of the media network, the audience comprising a plurality of audience segments;
computer-readable program code configured to receive advertising information associated with at least one advertisement;
computer-readable program code configured to generate a model for selling the inventory based on the past information;
computer-readable program code configured to generate potential sales information through a simulated selling of at least one of the plurality of audience segments using the model, the simulated selling being based on the potential information and the advertising information; and
computer-readable program code configured to generate an optimized transaction strategy for selling the plurality of audience segments for the at least one advertisement based on the potential sales information.

18. The computer-readable storage medium of claim 17, further comprising computer readable program code configured to execute the simulated selling according to an agent-based computational economics simulation.

19. The computer-readable storage medium of claim 18, further comprising computer readable program code configured to model buyers and sellers of the audience using agents of the agent-based computational economics simulation are configured to model buyers and sellers of the audience.

20. The computer-readable storage medium of claim 17, further comprising computer readable program code configured to generate the optimized transaction strategy to optimize revenue yield.
